(19) United States
(12) Patent Application Publication
(10) Pub. No.: US 2003/0227566 A1
(43) Pub. Date: Dec. 11, 2003

(54) Information transmission system having system clock synchronizing means and information transmitting apparatuses thereof

(76) Inventor: Yuuji Takenaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/437,519

(22) Filed: May 14, 2003

(30) Foreign Application Priority Data
Jun. 5, 2002 (JP) 2002-164549 (PAT.

(51) Int. Cl. H04N 9/44

(52) U.S. Cl. 348/500; 375/240.25

(57) ABSTRACT

An information transmission system where a receiving side apparatus selectively switches among a plurality of transmitting side apparatuses for connection, including a plurality of first information transmitting apparatuses, a second information transmitting apparatus for selectively receiving information from these first apparatuses, and a system clock synchronizing means comprised of a frequency information transmitting unit provided at the second transmitting apparatus side and transmitting frequency information F′ and system clock synchronizing units provided at the first information transmitting apparatus sides and using frequency information F′ distributed to them from the frequency information transmitting unit as master information, wherein shock (disturbance of information) occurring at the time of switching can be suppressed.

### BACKGROUND OF THE INVENTION

1. Field of the Invention

The present invention relates to an information transmission system having a system clock synchronizing means and information transmitting apparatuses comprising the same.

Such an information transmission system and information transmitting apparatuses can for example be widely applied to:

(i) Video/audio transmission systems using MPEG2 encoding;

(ii) MPEG2 codecs or MPEG2 encoders;

(iii) Multipoint conference units (MCU) for MPEG2; and

(iv) Transport stream (TS) multiplexing apparatuses for MPEG2

As systems, the present invention can cover for example remote monitoring systems monitoring different points on a highway, multipoint simultaneous conference systems, and remote monitoring systems for monitoring different points on a dam and its environs.

2. Description of the Related Art

While the present invention can be applied to general information transmission systems and general information transmitting apparatuses, to speed understanding, the following explanation will be given taking as a specific example a video/audio transmission system using MPEG2 coding and an MPEG encoder and MPEG2 decoder (MPEG2 codec).

A video/audio transmission system or transmitting apparatus using MPEG2 coding of the related art will be explained later with reference to FIG. 16 to FIG. 22. In general, there are two modes for synchronization of the system clock: use of a self-generated clock (first mode) and use of a line clock of a line switching network (second mode).

That is, in the above first mode, the for example 27 MHz transmitting side system clock in the MPEG2 encoder (or MPEG2 codec, hereinafter the same) is generated using a self-generated clock built into the MPEG2 encoder.

Further, in the above second mode, the line clock of the line switching network to which the MPEG2 encoder is connected is used as the transmitting side system clock for operation of the MPEG2 encoder (for example, see Japanese Unexamined Patent Publication (Kokai) No. 2000-324475 etc.)

Summarizing the problems to be solved by the invention, when selectively combining a plurality of MPEG2 encoders (hereinafter referred to as “transmitting apparatuses” and at least one MPEG2 decoder (or MPEG2 codec, same below) and connecting them through a line switching network, the group of the plurality of transmitting side transmitting apparatuses operate asynchronously from each other. Therefore, when switching connections between the transmitting side and receiving side, the receiving side MPEG2 decoder (hereinafter also referred to as a “transmitting apparatus”) must resynchronize with a different system clock than that used up to then. There has therefore been the disadvantages that, at the time of switching, a large disturbance occurs in the video/audio and a large shock (disturbance of information) occurs and that a long time was taken until stable operation was returned to.

These disadvantages are inherent and unavoidable in the first mode (self-generated clock mode), but do not occur under the second mode (line clock synchronization mode).

The second mode, however, suffered from the following problems:

If synchronizing the system clocks of both the transmitting side and receiving side transmitting apparatuses with the line clock of the transmission line (line switching network), since the line clock is constant within the same line switching network, even if the combination of the transmitting side and receiving side transmitting apparatuses is switched, no shock occurs at the time of resynchronization of the system clock and therefore the above disadvantages can be avoided.

Synchronization of the line clock and the system clock, however, requires phase comparison at a frequency of a common multiple of the line clock and the system clock in PLL units in the transmitting apparatuses. For example, if showing the relationship between the frequency division number and phase comparison frequency when the line (transmission line) clock is 6.312 Mbps and is 155.52 Mbps, the result becomes as follows (where the system clock is fixed to 27 MHz):

TABLE 1
Relationship Between Phase Comparison
Frequency and Frequency Division Number

| Phase | | | |
|---|---|---|---|
| comparison | | 6.312 M | 155.52 M |
| frequency | 27 M frequency | frequency | frequency |
| (kHz) | division number | division number | division number |
| 4 | 6750 | 1578 | 38880 |
| 8 | 3375 | 789 | 19440 |
| 24 | 1125 | 263 | 6480 |
| 40 | 675 | — | 3888 |
| 120 | 225 | — | 1296 |
| 360 | 75 | — | 432 |
| 1080 | 25 | — | 144 |

As shown in the above table, if the frequency of the line clock changes, the frequency division number changes along with it. Further, depending on the frequency of the line clock, there sometimes is no whole number frequency division number.

Therefore, in the second mode, there is the problem that there are limits to the available frequency of the line clocks and it is not possible to select any frequency as the system clock.

Further, when there is a line master clock at the line switching network side, the 27M system clock of the transmitting apparatus side is synchronized with that line master clock. Therefore, there is the problem that the second mode cannot be used for an information transmission system requiring that the 27M system clock be synchronized with the video system 27M self-generated clock.

Further, in the MPEG system, an I-picture is inserted cyclically in the video signal. The amount of data of the I-pictures is much greater than that of the P-pictures and B-pictures. Therefore, when a plurality of transmitting apparatuses (MPEG encoders) are connected as with a media-shared type line switching network, the transmitting apparatuses operate asynchronously with each other, and the data is transmitted in bursts to the line switching network without smoothing, depending on the timing, the timings of transmission of the I-pictures of the transmitting apparatuses may coincide whereby a large amount of data will end up being transmitted at the same point of time and the line switching network will become congested.

To prevent this congestion, it is necessary to design the line switching network bearing in mind the worst case scenario where I-pictures are transmitted from a plurality of transmitting apparatuses at the same timing. Therefore, there is the problem that when seen on the average, the line switching network is wastefully used and therefore the efficiency of utilization of the line switching network ends up falling.

### SUMMARY OF THE INVENTION

An object of the present invention is to provide an information transmission system having a system clock synchronizing means, and an information transmitting apparatus, able to set a system clock of any frequency, able to match a system clock with a self-generated clock of a video system, and able to avoid I-pictures from a plurality of video signal sources concentrating at the same timing.

To attain the above object, the system of the present invention is comprised of a plurality of first information transmitting apparatuses (1), a second information transmitting apparatus (2) for selectively receiving information from these apparatuses, and a system clock synchronizing means. The system clock synchronizing means is comprised of a frequency information transmitting unit (4) provided at the second transmitting apparatus (2) side and transmitting frequency information F′ and system clock synchronizing units (5) provided at the first information transmitting apparatus (1) side and using frequency information F′ distributed to them from the frequency information transmitting unit (4) as master information. Due to this, in the present invention, a receiving side apparatus suppresses shock (disturbance of information) occurring at the time of switching in a system selectively switching among a plurality of transmitting side apparatuses.

### BRIEF DESCRIPTION OF THE DRAWINGS

These and other objects and features of the present invention will become clearer from the following description of the preferred embodiments given with reference to the attached drawings, wherein:

FIG. 1 is a view of the basic configuration of an information transmission system according to the present invention;

FIG. 2 is a first part of a view of a first embodiment of the present invention;

FIG. 3 is a second part of a view of a first embodiment of the present invention;

FIG. 4 is a first part of a view of a second embodiment of the present invention;

FIG. 5 is a second part of a view of a second embodiment of the present invention;

FIG. 6 is a first part of a view of a third embodiment of the present invention;

FIG. 7 is a second part of a view of a third embodiment of the present invention;

FIG. 8 is a first part of a view of a fourth embodiment of the present invention;

FIG. 9 is a second part of a view of a fourth embodiment of the present invention;

FIG. 10 is a first part of a view of a fifth embodiment of the present invention;

FIG. 11 is a second part of a view of a fifth embodiment of the present invention;

FIG. 12 is a first part of a view of a sixth embodiment of the present invention;

FIG. 13 is a second part of a view of a sixth embodiment of the present invention;

FIG. 14 is a first part of a view of a general system clock synchronizing means;

FIG. 15 is a second part of a view of a general system clock synchronizing means;

FIG. 16 is a view of a first related art of an information transmission system;

FIG. 17 is a first part of a view of a second related art of an information transmission system;

FIG. 18 is a second part of a view of a second related art of an information transmission system;

FIG. 19 is a first part of a view of a third related art of an information transmission system;

FIG. 20 is a second part of a view of a third related art of an information transmission system;

FIG. 21 is a first part of a view of a fourth related art of an information transmission system; and

FIG. 22 is a second part of a view of a fourth related art of an information transmission system.

### DESCRIPTION OF THE PREFERRED EMBODIMENTS

Preferred embodiments of the present invention will be described in detail below while referring to the attached figures.

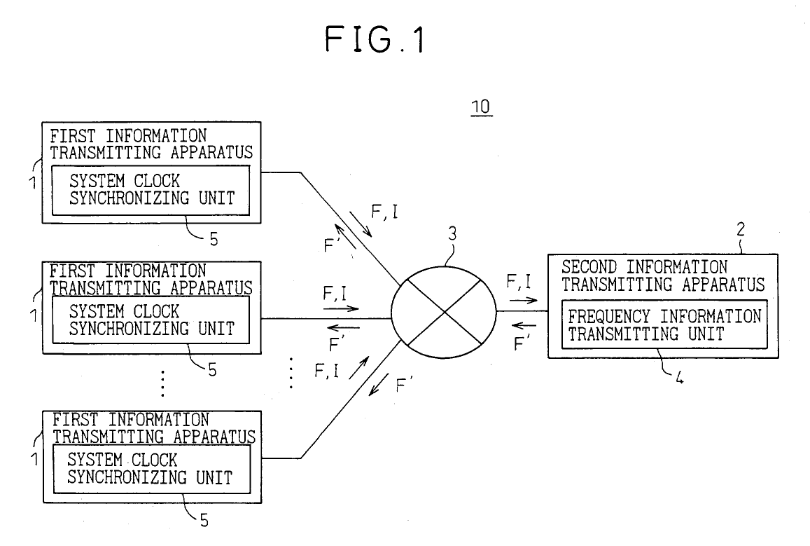

FIG. 1 is a view of the basic configuration of an information transmission system according to the present invention.

The information transmission system 10 shown in this figure is basically comprised of a plurality of first information transmitting apparatuses 1 for transmitting video/audio information and a second information transmitting apparatus 2 for selectively receiving said video/audio information from said first information transmitting apparatuses and further including a system clock synchronizing means for synchronizing system clocks between said first and second information transmitting apparatuses 1 and 2 through the medium of frequency information F relating to the system clock. Note that “video/audio” means just video or both video and audio.

In this system 10, the characterizing feature of the present invention lies in the system clock synchronizing means. The means is comprised of <1> a frequency information transmitting unit 4 provided at the second information transmitting apparatus 2 side and transmitting frequency information F′ and <2> system clock synchronizing units 5 provided at the first information transmitting apparatus 1 side and synchronizing the system clocks using the frequency information F′ distributed to them from the frequency information transmitting unit 4 as master information.

As a specific example, each first information transmitting apparatus 1 is comprised of at least an MPEG2 encoder, while the second information transmitting apparatus 2 is comprised of at least an MPEG2 decoder and the frequency information F′ includes a program clock reference (PCR). The PRC is a known reference value at the time of programming.

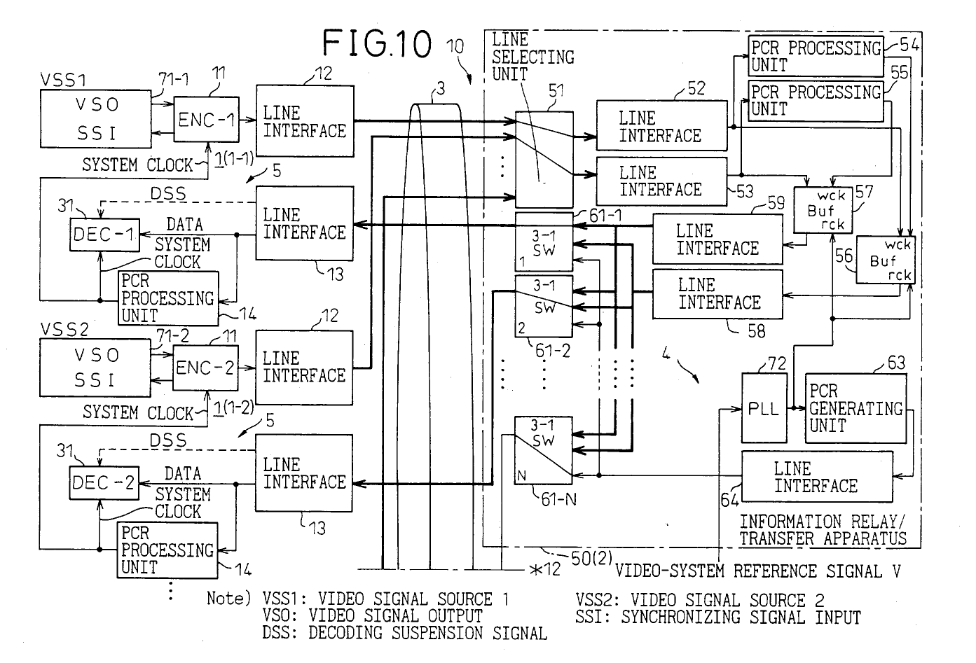

Due to the configuration of the above FIG. 1, the problems mentioned above are solved. That is, according to the configuration of FIG. 1, the frequency informations F from all of the first information transmitting apparatuses 1 are made uniform with the frequency information F′ distributed in common from the second information transmitting apparatus 2, so when an apparatus 2 connected to one apparatus 1 switches the destination of connection to another apparatus 1, the above-mentioned shock will of course not be caused at the time of switching, the frequency of the system clock can be freely selected, and therefore it is possible to match the system clock with the video reference signal (V of FIG. 10) or possible to adjust the timings of transmission of the I-pictures from the apparatuses 1 not to match with each other.

First, the system clock synchronizing means will be explained.

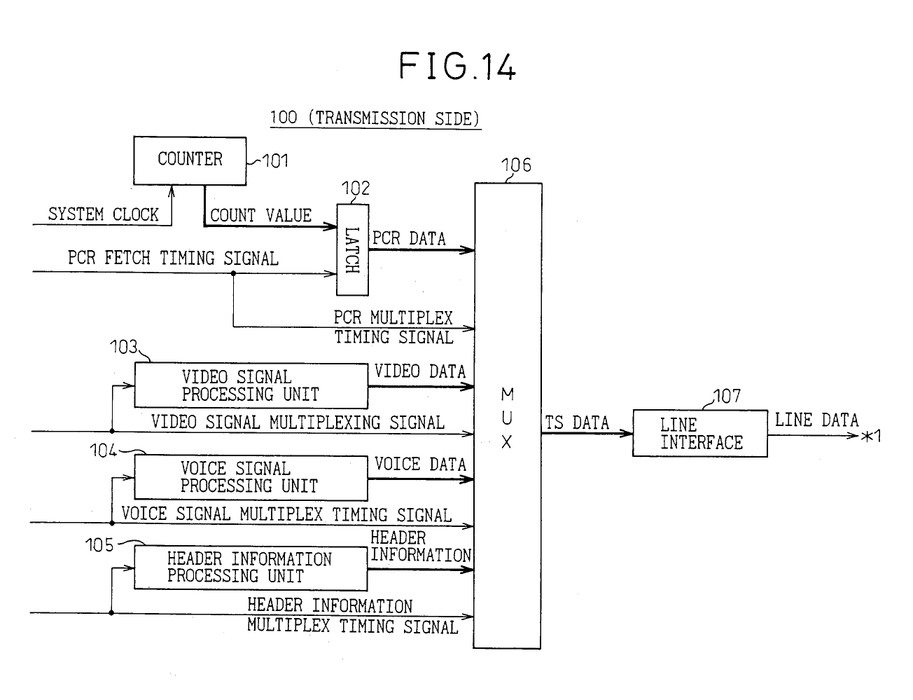

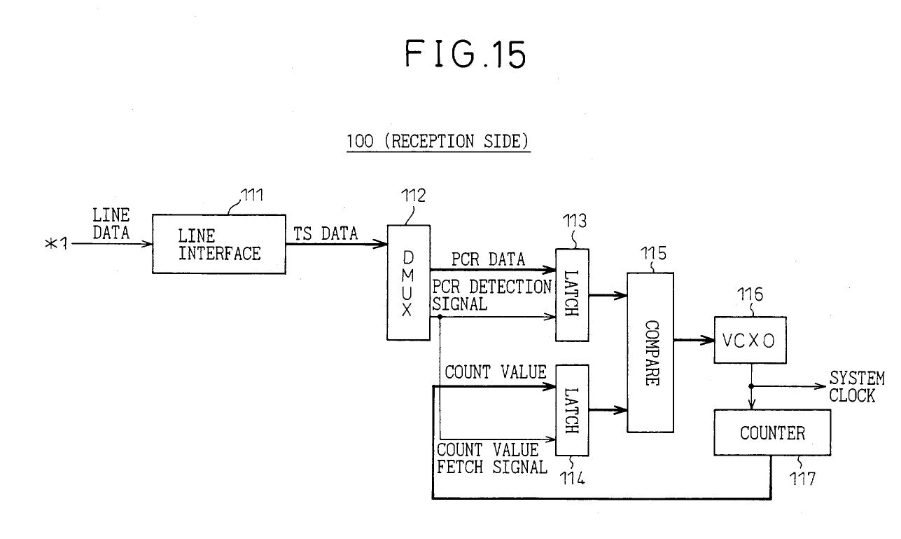

FIGS. 14 and 15 are first and second parts of a view of a general system clock synchronizing means.

FIG. 14 shows the information transmitting side, while FIG. 15 shows the information receiving side.

The operation of the transmitting side (FIG. 14) is as follows.

At the timing of transmitting PCR data on a TS stream, the count value of the counter 101 operating by the system clock is fetched and multiplexed with the inherent information at the multiplexer (MUX) unit 106. This data is then transmitted through a line interface 107 to the receiving side (FIG. 15).

The operation of the receiving side (FIG. 15) is as follows.

The above data is transmitted through a line interface 111 to a demultiplexer (DMUX) unit 112.

At the timing where the DMUX unit 112 detects the PCR data, the internal count value of a counter 117 is fetched and compared with the transmitted PCR data at a comparison unit 115.

This compared value is used as a control signal for a VCXO 116. The oscillation frequency (F) of the VCXO 116 is controlled so that the result of comparison becomes 0. Due to this, the system clock of the receiving side is made to match with the system clock of the transmitting side.

The PCR packet (line data at right end of FIG. 14) includes the system clock frequency information (PCR) of a transmitting side transmitting apparatus 1, so the system clock recovered from the PCR packet received at the receiving side transmitting apparatus 2 is completely synchronized with the transmitting side system clock of the opposing transmitting apparatus (1).

Supplementing the explanation of the rest of the components, in FIG. 14, reference numeral 102 indicates a latch unit for latching the count value and the PCR fetched signal, 103 and 104 indicate processing units for processing the inherent video signal or audio signal from a camera or microphone and input the same to the MUX unit 106, and 105 indicates a processing unit for header information to be added to the header of the packet forming the line data to be transmitted.

On the other hand, in FIG. 15, reference numeral 113 indicates a latch unit for latching the PCR data from the transmitting side at the PCR detection timing, while 114 indicates a latch unit for latching the internal count value of the counter 117 at that PCR detection timing (count fetching timing).

Next, embodiments based on the present invention will be explained in comparison with examples of the related art.

### First Embodiment: One-Way Communication By Leased Line in N-to-1 Connection

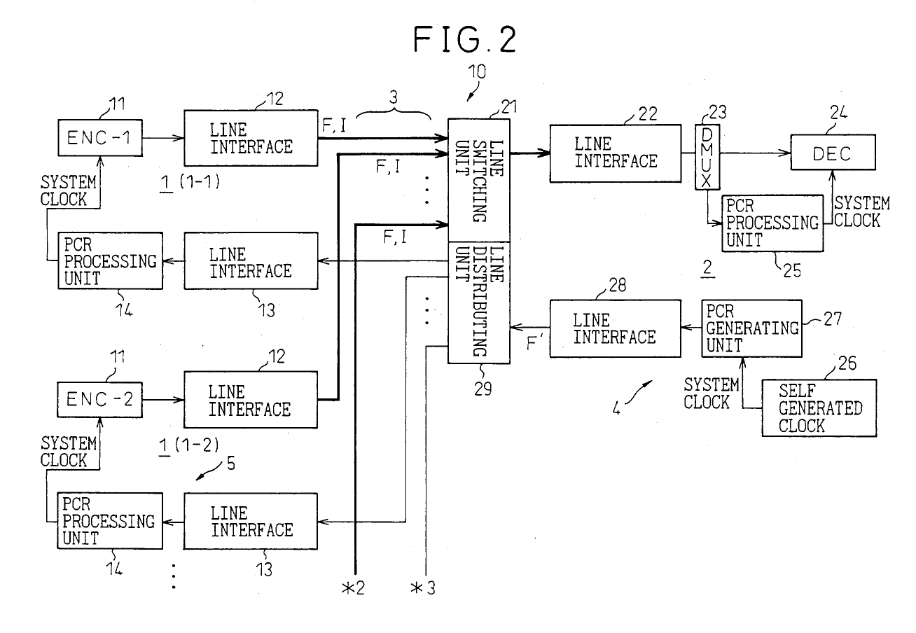

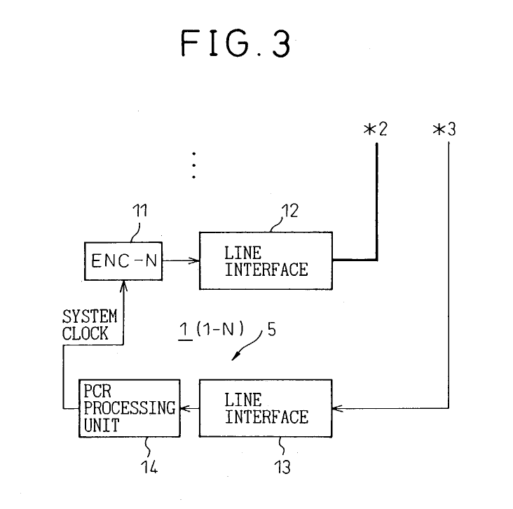

FIG. 2 and FIG. 3 are parts of a view of a first embodiment according to the present invention.

The information transmission system 10 in the first embodiment is comprised of a plurality of first information transmitting apparatuses (1-1, 1-2 to 1-N) and a second information transmitting apparatus 2 opposing them through a line switching network 3.

The plurality (N) of first information transmitting apparatuses 1 are all of substantially the same configuration, so here the apparatus 1 (1-1) at the top left of FIG. 2 will be focused on. The apparatus 1 has an encoder (ENC-1) 11 and a line interface 12 (see 107 in FIG. 1) for transmitting its output to the line switching network 3 (same as in the related art). Further, it has a line interface 13 and a PCR processing unit 14 forming the characterizing features of the present invention.

The video/audio information (I) and frequency information (F) from the first information transmitting apparatus 1 are transmitted to the second information transmitting apparatus 2 side and input to a line switcher 21. Note that this line switcher 21 simultaneously receives as input not only the video/audio information I and frequency information F from the above transmitting apparatus 1 (1-1), but also similar video/audio information I and frequency information F from the other transmitting apparatuses 1 (1-2 to 1-N).

Which transmitting apparatus 1 (1-1, 1-2 to 1-N) to select to receive information (I, F) from is determined at the second information transmitting apparatus 2 side by for example judgment of the operator. Along with this decision, the line switcher 21 selects and receives the information (I, F) from one of the first information transmitting apparatuses 1 (1-1, 1-2 to 1-N), for example, the apparatus 1-1.

This received information is input through a line interface 22 (see 111 of FIG. 15) to a DMUX unit 23 (see 112 of FIG. 15). There, the video/audio information (I) is input to a decoder (DEC) 24 where it is reproduced in synchronization with the system clock. This is then supplied to for example a monitor TV (not shown). In this case, the system clock is generated at a PCR processing unit 25 (see 113 to 117 of FIG. 15) based on the received frequency information (F), that is, PCR (same as in the related art).

The characterizing features of the present invention in this second information transmitting apparatus 2 are the self-generated clock 26, PCR generating unit 27 (see 101 and 102 of FIG. 14), and line interface 28. Another characterizing feature is a line distributing unit 29.

Compared with FIG. 1, the frequency information transmitting unit 4 of FIG. 1 corresponds to the above components 26 to 29 of FIG. 2. Further, the system clock synchronizing unit 5 of FIG. 1 corresponds to the line interface 13 and PCR processing unit 14 of FIG. 2 explained above.

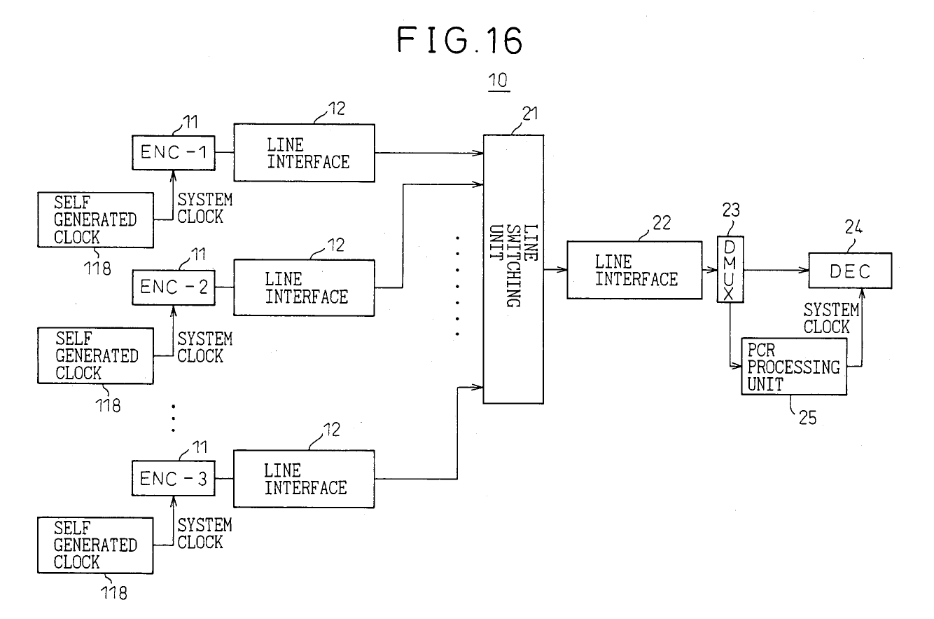

The fundamental differences in the configuration of the present invention shown in FIG. 2 and FIG. 3 from the configuration of the related art will become clear from a comparison with FIG. 16.

FIG. 16 is a view of a first related art of an information transmission system. Note that throughout the figures, similar components are assigned the same reference numerals or symbols.

The first point of difference between the first embodiment (FIG. 2 and FIG. 3) and the first related art (FIG. 16) is that in the first embodiment, the frequency information transmitting unit 4 (26 to 29) is provided at the apparatus 2 side. Along with this, the apparatus 1 side is provided with system clock synchronizing units 5 (13, 14). On the other hand, the self-generated clock 118 for each apparatus 1, which was essential in the first related art, becomes unnecessary in the first embodiment.

As explained above, in the first embodiment, the self-generated clock 118 of the first related art was eliminated, but it becomes necessary to forward the frequency information from the frequency information transmitting unit 4 to the system clock synchronizing units 5 through the line distributing unit 29 and the line switching network 3. This may appear to be disadvantageous at first glance compared with the first related art. However, it does not become that great a disadvantage. The reason is that the amount of data for transmitting the frequency information F′ is extremely small. Even if this is distributed to all apparatuses 1 in a star fashion, it will not become a particular obstacle.

The technical idea of the first embodiment is common with those of the second embodiment to sixth embodiment described later. This technical idea will be summarized again here.

That is, after deciding the apparatus serving as the clock master and generating the system clock of the transmitting side at the slave side apparatus 1 based on the system clock of the receiving side apparatus (2), it is possible to make the system clocks match between opposing apparatuses (1 and 2). Further, the clock recovery by the PCR packet is governed only by the time of arrival of the packet and the transmitted data, so is unrelated to the speed of the line switching network and is not restricted by the speed of the network.

Due to this, it becomes possible to synchronize the system clocks of a plurality of encoders (1) connected to a single media-shared type network (3). Further, since the system clocks of the encoders (1) are identical, it becomes possible to set the timings of transmission of the I-pictures from the encoders (1) to a certain fixed phase relationship as in the later explained seventh embodiment and therefore possible to shift the timings of transmission of the I-pictures by the encoders (1) so as to prevent congestion of the network (3).

In other words, each apparatus 1 synchronizes its transmitting side system clock with the receiving side system clock of the apparatus 1. If making the transmitting side system clock of the apparatus 2 the master clock and having each apparatus 1 synchronize the transmitting side system clock with the received clock of the apparatus 1 side, it is possible to slave the transmitting side system clocks of all apparatuses 1 to the master clock of the apparatus 2 side. Therefore, in the apparatus 2, no matter to which apparatus 1 side destination switched to, the receiving side system clock recovered from the PCR packet transmitted from there becomes constant. As a result, even if switching the selection of the transmitting side apparatus (1), no shock occurs at the time of resynchronization of the system clock and therefore a long time will not be taken until reaching stable operation at the time of switching the connection destination.

### Second Embodiment: Two-Way Communication By Leased Line for N-to-1 Connection

The second embodiment shares the same technical idea as the above first embodiment. The characterizing feature of the second embodiment is as follows.

That is, it is characterized by the point of transmitting not only the frequency information F′, but also the video/audio information to the non-selected first information transmitting apparatuses 1 whose video/audio information I is not received by the second information transmitting apparatus 2.

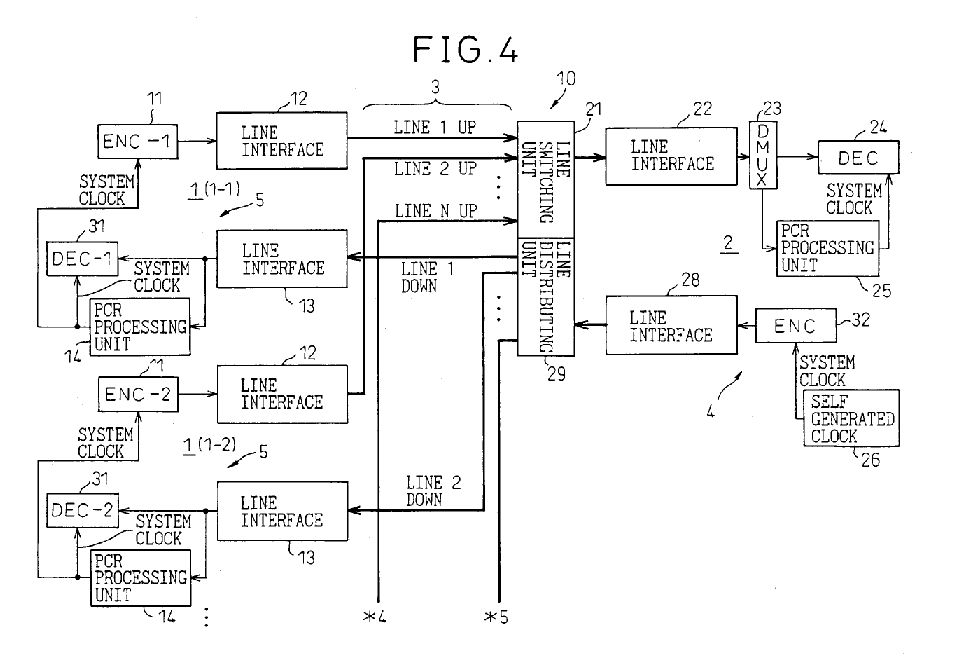

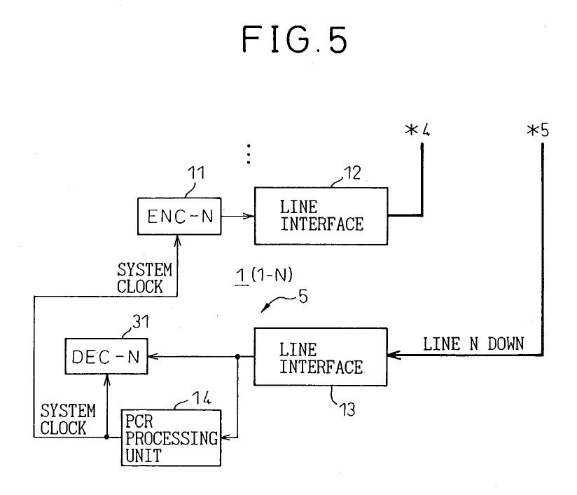

FIG. 4 and FIG. 5 are parts of a view of the second embodiment of the present invention.

Compared with the first embodiment (FIG. 2 and FIG. 3), in the second embodiment, an encoder (ENC) 32 is added at the second information transmitting apparatus 2 side. Further, at the first information transmitting apparatus 1 side, decoders (DEC-1, DEC-2 . . . DEC-N) 31 are added. Due to this, as explained above, by transmitting video/audio information in addition to the frequency information from the apparatus 2 to the apparatuses 1, the apparatuses 1 can also monitor the information from the apparatus 2.

In the case of the two-way communication in the second embodiment, the data which has to be transmitted to the non-selected apparatuses 1 among the plurality of apparatuses 1 includes video data as well, and further, the amount of that data is large. So this may appear at first glance to be a demerit, however, there is the merit that even such non-selected apparatuses 1 can monitor the video from the apparatus 2, so this is not that great a demerit. Further, if use is made of a leased line securing a certain line capacity at all times, it is not necessary to go to the trouble to reduce the amount of data sent to the non-selected apparatuses 1.

The fundamental differences in the configuration of the present invention shown in FIG. 4 and FIG. 5 from the configuration of the related art will become clear from a comparison of the figures.

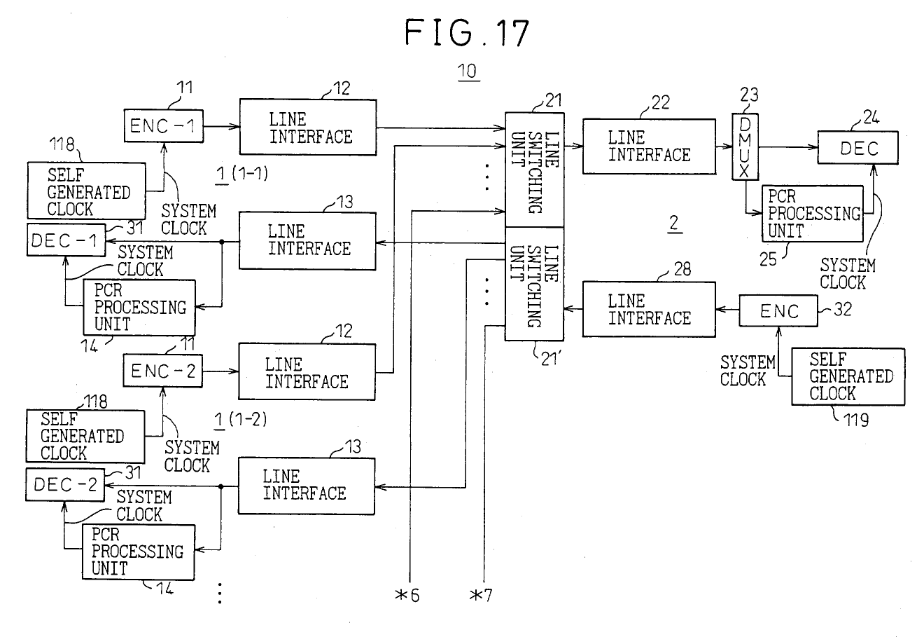

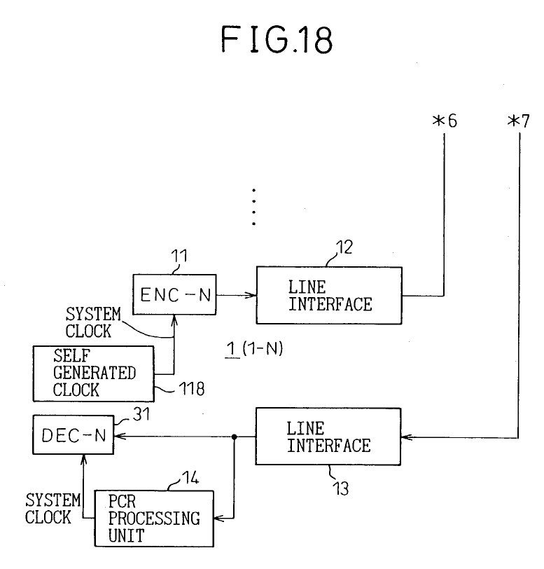

FIG. 17 and FIG. 18 are parts of a view of a second related art of an information transmission system.

In the second related art, as shown in FIG. 17 and FIG. 18, each of the first information transmitting apparatuses is provided with a self-generated clock 118. This is the fundamental difference from the present invention.

Further, in the second related art, the configurations at the left and right of the line switcher 21 (uplink) and the configurations at the top and bottom of the line switcher 21′ (downlink) are exactly the same in terms of the flow of information. However, the uplink and the downlink are completely isolated. That is, the self-generated clocks 118 at the apparatus 1 side and the self-generated clock 119 at the apparatus 2 side are independent from each other. Therefore, the self-generated clock 119 of the apparatus 2 side is completely different in function from the self-generated clock 26 of the apparatus 2 side in the present invention. Further, the present invention differs in configuration from the above-mentioned second mode (line clock mode). This will be explained below.

The first embodiment and the second embodiment according to the present invention explained above can eliminate the disadvantages of the above-mentioned first mode (self-generated clock mode) and second mode (line clock mode) of the related art. Further, they can eliminate the above-mentioned problems suffered by the second mode. Here, the differences in configuration of the first embodiment (one-way communication) and second embodiment (two-way communication) from the second mode (one-way communication and two-way communication) will be explained.

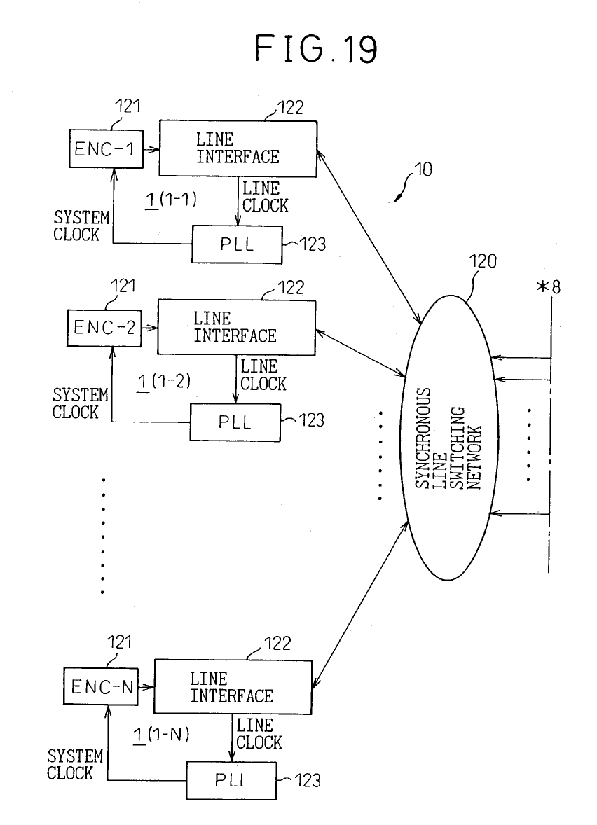

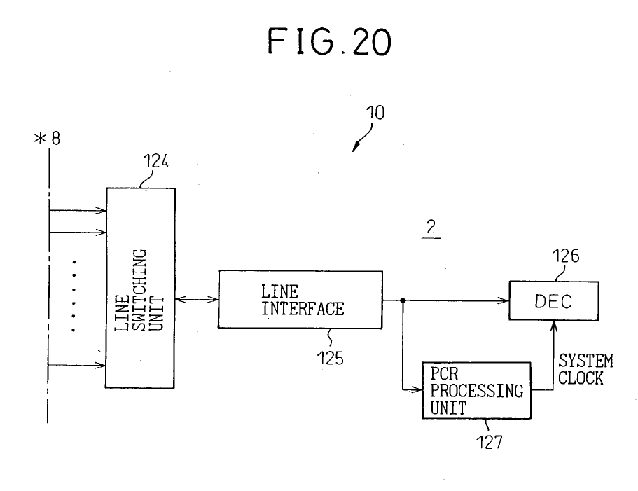

FIG. 19 and FIG. 20 are parts of a view of a third related art of an information transmitting system.

### Third Related Art: One-Way Communication Through Synchronous Line Switching Network For N-to-1 Connection

The configuration of FIG. 19 and FIG. 20 is for one-way communication and corresponds to the configuration of the first embodiment (FIG. 2 and FIG. 3). The first information transmitting apparatus 1 side is provided with PLL units 123 for synchronization with the line clock of the synchronous line switching network 120.

Note that the other components 121, 122, 125, 126, and 127 in FIG. 19 and FIG. 20 are substantially the same as the corresponding components 11, 12, 22, 24, and 25 in FIG. 2 and FIG. 3.

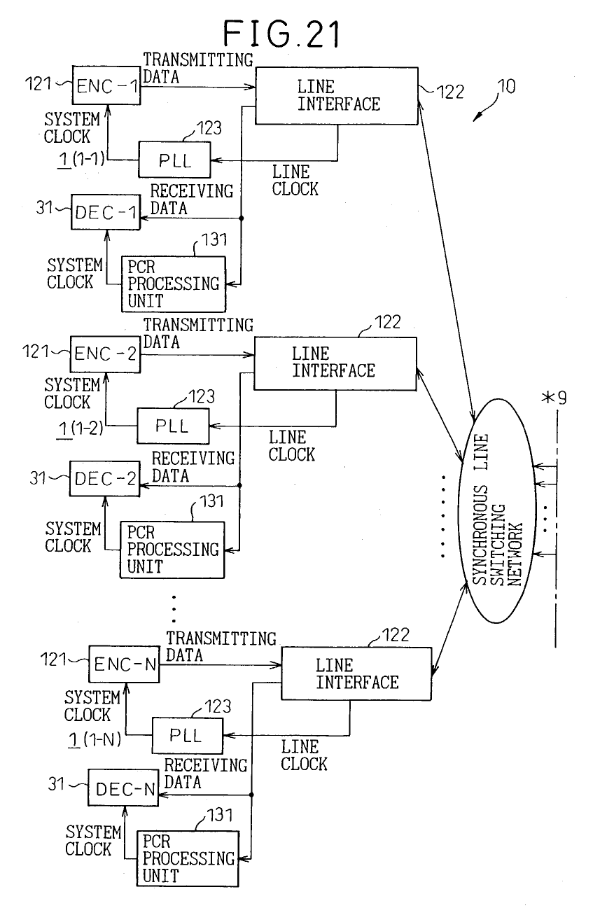

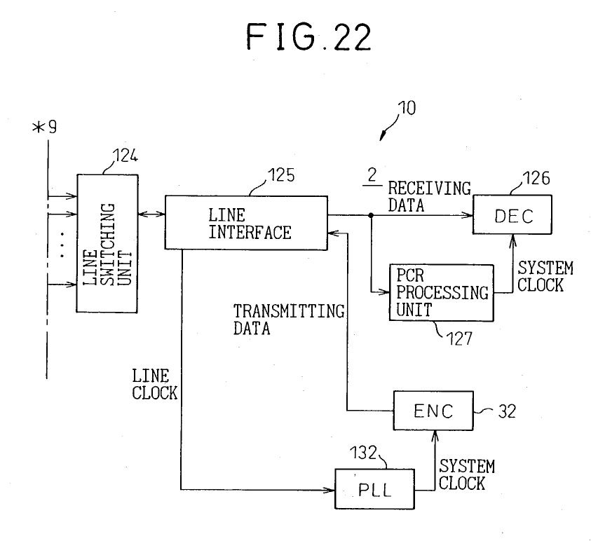

FIG. 21 and FIG. 22 are parts of a view of a fourth related art of an information transmitting system.

### Fourth Related Art: Two-Way Communication Through Synchronous Line Switching Network For N-to-1 Connection

The configuration of FIG. 21 and FIG. 22 relates to two-way communications and corresponds to the configuration of the second embodiment (FIG. 4 and FIG. 5). The first information transmitting apparatus 1 side is provided with PLL units 123 for synchronization with the line clock of the synchronous line switching network 120. Similarly, the second information transmitting apparatus 2 side is provided with a PLL unit 132 for synchronization with the line clock.

### Third Embodiment: Two-Way Communication Through Bandwidth Shared Type Line Switching Network For N-to-1 Connection

The characterizing feature of the third embodiment is that the transmission to non-selected first information transmitting apparatuses 1 whose video/audio information I is not received by the second information transmitting apparatus 2 is only the frequency information F′ and the minimum extent of information required for forwarding of information.

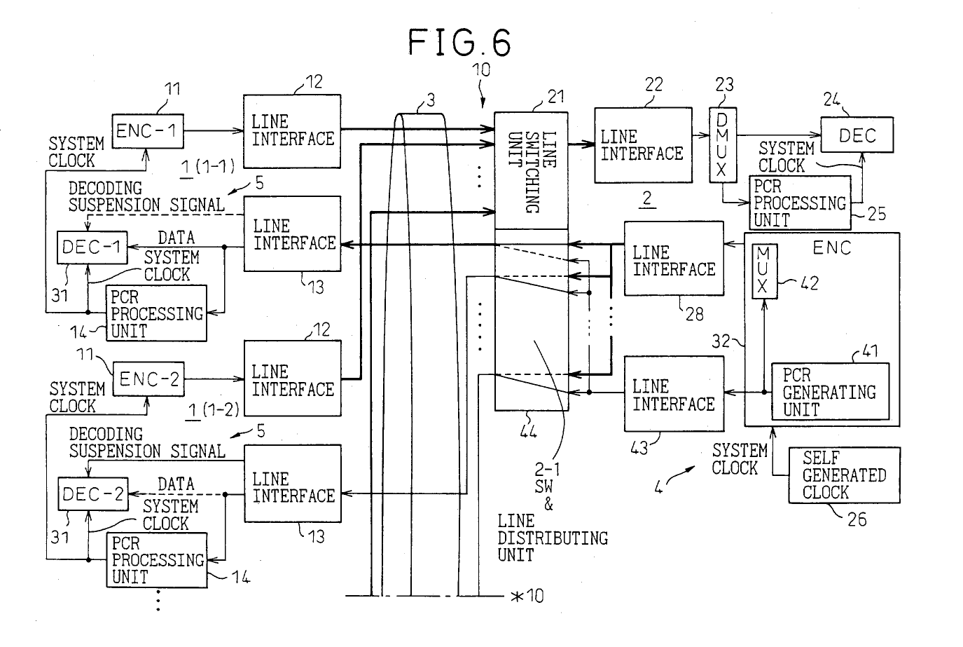

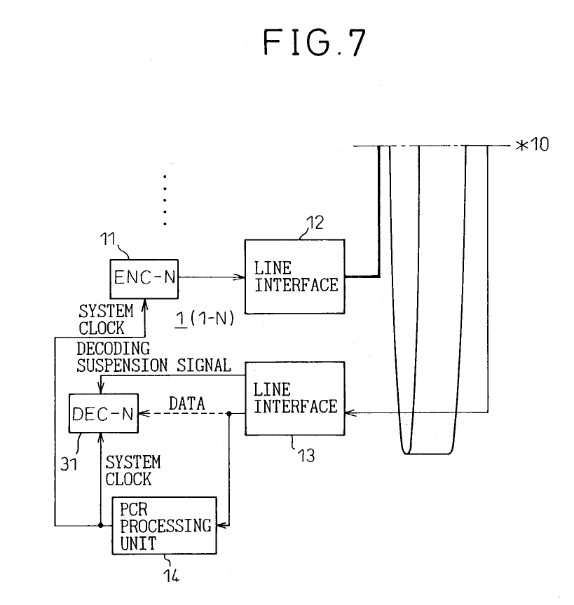

FIG. 6 and FIG. 7 are parts of a view of the third embodiment of the present invention.

The configuration of the third embodiment resembles the configuration of the second embodiment shown in FIG. 4 and FIG. 5, but differs on the following points.

First, the line switching network 3 is a bandwidth-shared type line switching network in the third embodiment. Further, in the third embodiment, the output from the PCR generating unit 41 in the encoder (ENC) 32 is used. This output is originally input to the MUX unit 42 (see 106 of FIG. 14), but this output is transmitted to the apparatus 1 side through the line interface 43.

In this case, the 2-1 switch & line distributing unit 44 is introduced. The switch/distributing unit 44 switches to either the video/audio information side from the encoder 32 (interface 28 side) or frequency information side (interface 43 side) and connects to the apparatuses 1.

The apparatus 1 receiving the video/audio information (for example, 1-1) turns off the illustrated “decoding suspension signal” and reproduces the data. On the other hand, the other apparatuses 1 (1-2 to 1-N) not receiving the video/audio information turn on the decoding suspension signal and do not reproduce data, but execute operations for synchronization of the system clocks by the PCR received from the apparatus 2.

The third embodiment is adopted to the case where the transmission line (line switching network 3) used is a frame relay, ATM, LAN, etc. and the transmission capacity is not always secured. Therefore, the effect when it is necessary to transmit a large amount of data to non-selected apparatuses 1 (in the example of the figures, 1-2 to 1-N) is great.

Therefore, in the third embodiment, the data to be transmitted to the apparatus 1 side is divided into data to be transmitted to the non-selected apparatuses 1 and data to be transmitted to the selected apparatus 1. Further, the non-selected apparatuses 1 are transmitted only the PCR packets and other minimum extent of packets.

Therefore, according to the third embodiment, it is possible to raise the efficiency of utilization of a bandwidth-shared type line switching network (frame relay, ATM, etc.)

### Fourth Embodiment: Two-Way Communication Through Bandwidth-Shared Type Line Switching Network For N-to-N Connection

The second information transmitting apparatus 2 in the fourth embodiment has a frequency information transmitting unit 4 in the information relay/transfer apparatus for transferring video/audio information I between any two of the plurality of first information transmitting apparatuses 1. The non-selected first information transmitting apparatuses 1 other than the above selected any two first information transmitting apparatuses 1 synchronize system clocks with the second information transmitting apparatus 2.

The fourth embodiment is suited for the case of multipoint simultaneous conferences through for example frame relay, ATM, or other bandwidth-shared type line switching networks.

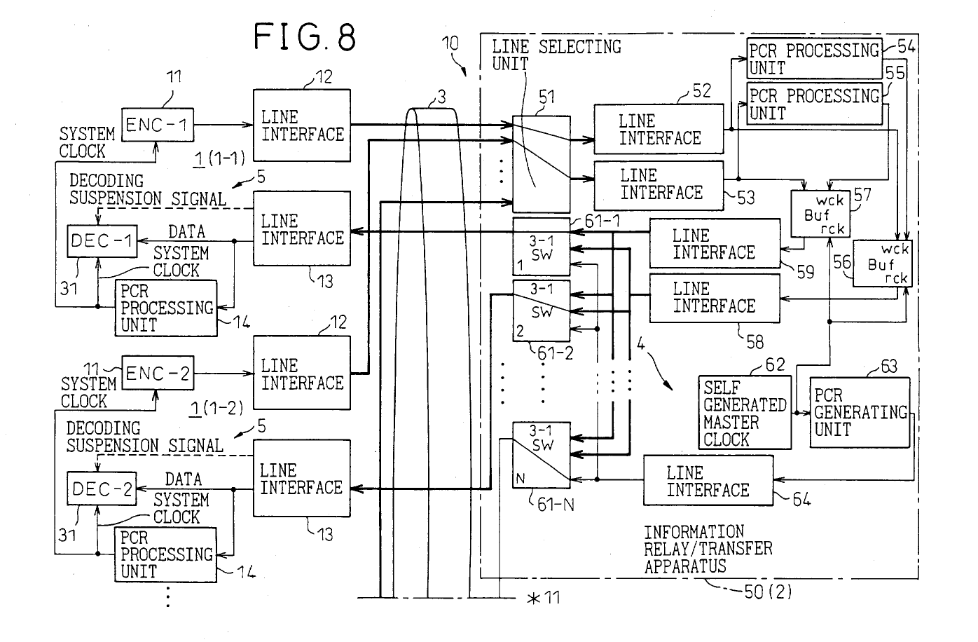

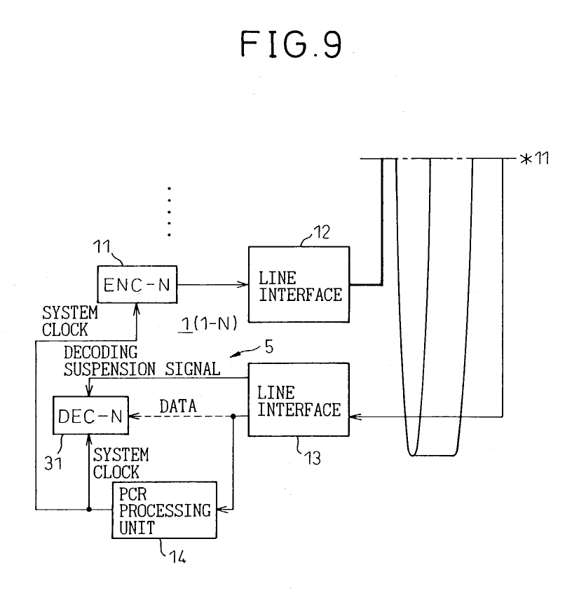

FIG. 8 and FIG. 9 are parts of a view of the fourth embodiment according to the present invention.

As shown in FIG. 8 and FIG. 9, the configuration of the first information transmitting apparatus 1 side in the configuration of the fourth embodiment is substantially the same as in the third embodiment (FIG. 6 and FIG. 7), but the configuration at the second information transmitting apparatus 2 side differs in that an information relay/transfer apparatus 50 is introduced. This apparatus 50 corresponds to the above-mentioned MCU.

According to the example shown in FIG. 8 and FIG. 9, information is transferred between one apparatus 1-1 and another apparatus 1-2. Therefore, the line selecting unit 51 selects only the path between the apparatus 1-1 and apparatus 1-2.

Information from the apparatus 1-1 is output through the line selecting unit 51 from the line interface 52 and stored once in the buffer 56. The buffer 56 absorbs the signal processing time and fluctuations due to transmission delays in the apparatus 50. Information is written into the buffer 56 in accordance with a write clock (wck). This write clock is generated by the PCR processing unit 54 (see FIG. 15).

The same configuration (53, 55, 57) as the above is present for the apparatus 1-2 as well.

On the other hand, information from the apparatus 1-1 stored in the buffer 56 is later read out and supplied through the line interface 58 to the 3-1 switch group 61. This information is sent through the second 3-1 switch 61-2 to the destination apparatus 1-2.

The above configuration and operation also apply when reading information from the apparatus 1-2 stored in the buffer 57 and sending it to the destination apparatus 1-1. In this case, the information is transmitted through the line interface 59 and the first 3-1 switch 61-1.

Information is read from the above buffers 56 and 57 by a read clock (rck). The clock (rck) is generated by the self-generated master clock 62.

On the other hand, according to the present invention, the output of the self-generated master clock 62 is supplied to the PCR generating unit 63 (41 in FIG. 6) in the same way as the configuration of FIG. 6. The PCR packets generated here are distributed through the line interface 64 to the apparatuses (1-3 to 1-N) other than the apparatuses 1-1 and 1-2 in the conference in the same way as the case of FIG. 6. Therefore, the switches corresponding to these apparatuses (1-3 to 1-N), as shown for example for the 3-1 switch 61-N of FIG. 8, select the PCR packet and send it to the apparatus 1 (1-N). Therefore, the components 62, 63, and 64 form the frequency information transmitting unit 4 of FIG. 1.

In short, in the fourth embodiment, in the case of N-to-N connection, information is not directly communicated between the apparatuses 1 and the apparatus 2, but the information relay/transfer apparatus 50 is provided between them and the transmitting side system clock of the apparatus 50 is used as the master clock of the apparatus 1 side. Further, the receiving side system clock of the apparatus 1 side is locked to the transmitting side system clock of the apparatus 50 by being recovered from the transmitted PCR packet. Therefore, if synchronizing the transmitting side clocks of the apparatuses 1 with the receiving side clocks, it is possible to synchronize the system clocks of all of the apparatuses 1.

Note that when the transmission of a large amount of data including video data to the non-selected apparatuses 1 becomes a problem, this may be dealt with in the same way as the case of the N-to-1 connection (FIG. 6 and FIG. 7).

### Fifth Embodiment: System For Synchronization With Video System Clock

The fifth embodiment is characterized in that each of the plurality of first information transmitting apparatuses 1 is provided with a video signal source (71) and in that the frequency information transmitting unit 4 in the information relay/transfer apparatus 50 is synchronized with a video-system reference signal (V) from the outside and the video signal sources are synchronized with this video-system reference signal.

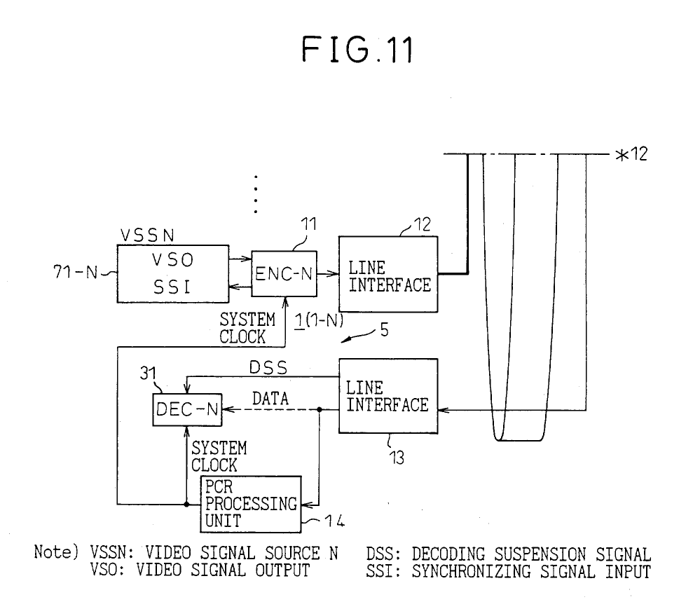

FIG. 10 and FIG. 11 are parts of a view of the fifth embodiment according to the present invention.

As shown in FIG. 10 and FIG. 11, the configuration of the fifth embodiment is the same as the configuration of the fourth embodiment (FIG. 8 and FIG. 9) in large part. The points of difference are that, in the fifth embodiment, at the first information transmitting apparatus 1 side, each apparatus 1 is shown with a video signal source 71 (71-1, 71-2 to 71-N) and that, further, in the information relay/transfer apparatus 50 at the second information transmitting apparatus side, a PLL unit 72 is adopted instead of the self-generated master clock 62 used in the fourth embodiment. This PLL unit 72 operates in synchronization with the video-system reference signal V.

Eventually, each video signal source 71 operates in synchronization with the video-system reference signal V.

In short, in the fifth embodiment, since the apparatus 50 operates by a system clock synchronized with the external video-system reference signal V, the system clocks of all of the apparatuses 1 for video coding linked with the apparatus 50 are synchronized with the video-system reference signal V input to the apparatus 50.

Therefore, by synchronizing the system clocks with the line clock, achievement of both synchronization of system clocks among apparatuses 1 and synchronization of the system clocks and video signal, which was impossible in a mode of synchronization of individual system clocks for the apparatuses (above explained second mode), becomes possible in the fifth embodiment.

Giving one example, in a system linking remote video signal sources 71 with a central broadcasting station (or TV studio), there are frequent requests for synchronization of the clocks of the video signal sources 71 with the clock of the broadcasting station. The fifth embodiments meets this request.

### Sixth Embodiment: System Preventing Simultaneous Generation Of I-Pictures From Apparatuses 1

The sixth embodiment is characterized in that each of the plurality of first information transmitting apparatuses 1 is provided with an I-picture generation timing control unit (81) and in that the generation of I-pictures transmitted from the first information transmitting apparatuses 1 is shifted from each other with reference to the timing of arrival of the frequency information F′ from the frequency information transmitting apparatus 4 under the control of this I-picture generation timing control unit (81).

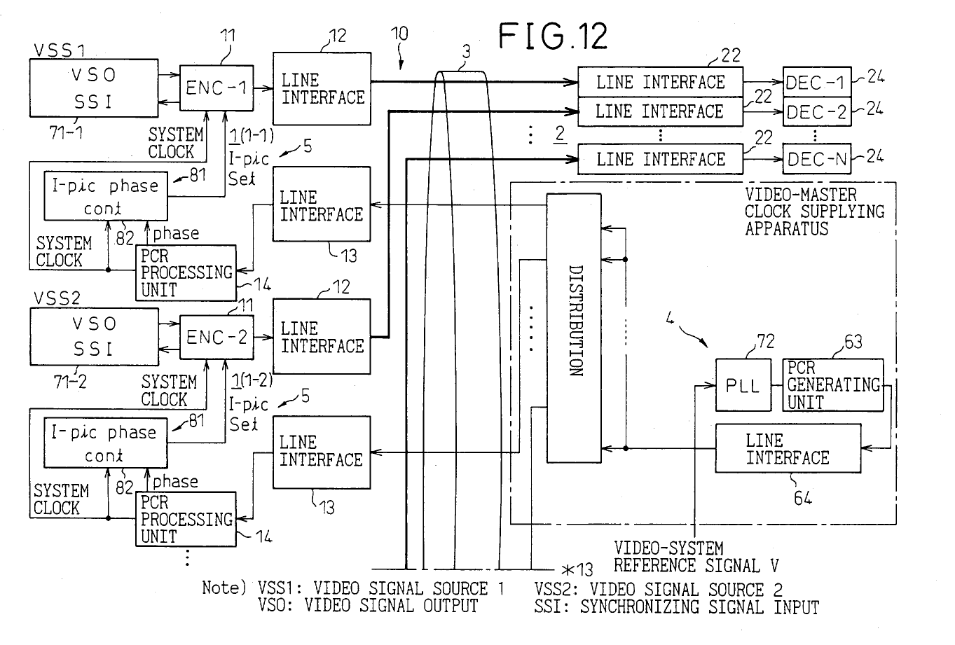

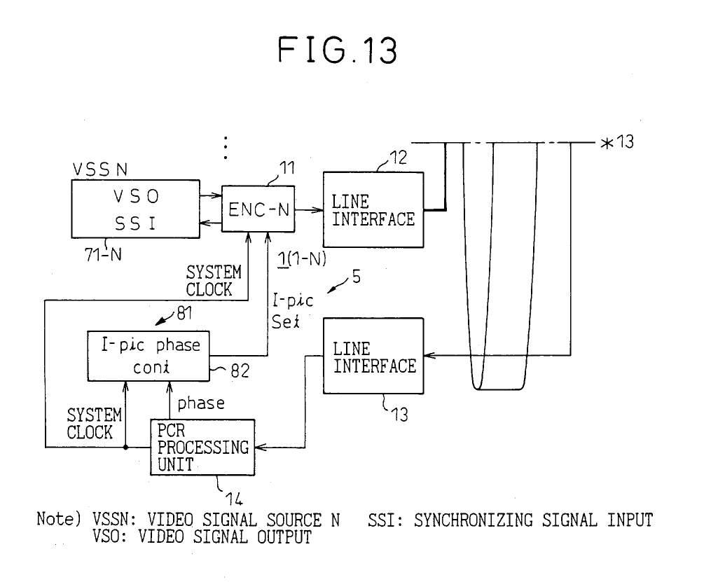

FIG. 12 and FIG. 13 are parts of a view of a sixth embodiment of the present invention.

The component to be particularly noted in the sixth embodiment is the I-picture generation timing control unit 81 provided at each apparatus 1. More specifically, this is shown as an I-picture phase control circuit 82.

Each PCR processing unit 14 receives a PCR common to all apparatuses 1 and gives its reference phase (“phase”) to the circuit 82. The circuit 82 determines the timing of generation of the I-picture based on the phase timing shifted by a predetermined phase from the reference phase (I-picture set) and starts up the encoder 11 based on this. Each circuit 82 is given a slightly different phase amount from the others as the above predetermined phase.

Therefore, it becomes possible to disperse the timings of generation of the I-pictures from the apparatuses 1 and avoid the above-mentioned congestion of the line switching network.

Note that as the configuration at the apparatus 1 side in the configuration shown in FIG. 12 and FIG. 13, use was made of the same configuration as in FIG. 10 and FIG. 11, but the invention is not limited to this.

On the other hand, as the configuration at the apparatus 2 side in FIG. 12, a modified configuration of FIG. 10 and FIG. 11 was shown, but this modified configuration has not direct relationship with the gist of the sixth embodiment.

Above, a detailed explanation was given of an information transmission system 10 according to the present invention, but the characterizing features of the present invention can also be found in the first information transmitting apparatuses 1 of the system 10 themselves and in the second information transmitting apparatus 2 itself.

That is, the first information transmitting apparatus 1 is one information transmitting apparatus among a plurality of information transmitting apparatuses 1 each selectively supplying video/audio information to a remote information transmitting apparatus 2 and operating by a system clock, provided with a system clock synchronizing unit 5 operating with received frequency information F′ relating to the system clock distributed from the remote information transmitting apparatus 2 for synchronization of a system clock with the remote information transmitting apparatus 2.

Further, the second information transmitting apparatus 2 is an information transmitting apparatus working with a plurality of remote information transmitting apparatuses 1 each operating based on a system clock so as to selectively receive video/audio information I from the plurality of remote information transmitting apparatuses 1, provided with a frequency information transmitting unit 4 for distributing frequency information F′ relating to the system clock to the plurality of remote information transmitting apparatuses 1 in common to enable each of the plurality of remote information transmitting apparatuses 1 to synchronize its system clock with the information transmitting apparatus 2.

Summarizing the effects of the invention, as explained above, the present invention has the following effects.

Even when the receiving side apparatus 2 switches the destination transmitting side apparatus 1, the system clock of the receiving side apparatus 2 can be held constant. Due to this, the shock occurring at the time of switching can be reduced.

Further, the system clocks can be synchronized at a plurality of transmitting side apparatuses 1 without being limited by the line clock. In particular, it becomes possible to synchronize the system clocks of a plurality of apparatuses 1 even when an external apparatus becomes the master for both the line clock and the video clock.

Further, since the system clocks of all of the encoders (ENC) can be synchronized with the system clock of the reference apparatus 2, if the video signal sources (71) connected to the encoders (ENC) and the encoders are synchronized, synchronization of the video signal sources also becomes possible. Therefore, when there is a master clock at a video signal source (71) side, by making the apparatus 2 serving as the system clock master synchronize with the video signal master (V) and making the video signal sources (71) connected to the encoders (ENC) synchronize with the encoders (ENC), the system clocks and the video clocks can be simultaneously synchronized.

Further, when a plurality of encoders (ENC) share a media-shared type line switching network, the timing of generation of I-pictures from the apparatuses 1 can be dispersed, so the line switching network can be effectively used due to the statistical multiplexing effect.

While the invention has been described with reference to specific embodiments chosen for purpose of illustration, it should be apparent that numerous modifications could be made thereto by those skilled in the art without departing from the basic concept and scope of the invention.

What is claimed is:

1. An information transmission system comprising a plurality of first information transmitting apparatuses for transmitting video/audio information and a second information transmitting apparatus for selectively receiving said video/audio information from said plurality of first information transmitting apparatuses and including a system clock synchronizing function unit which synchronizes system clocks between said first and second information transmitting apparatuses through the medium of frequency information relating to the system clock, wherein
said system clock synchronizing function unit has:
a frequency information transmitting unit provided at said second information transmitting apparatus side and transmitting frequency information and
system clock synchronizing units provided at said first information transmitting apparatus side and synchronizing said system clocks using said frequency information distributed to them from said frequency information transmitting unit as master information.

2. An information transmission system as set forth in claim 1, wherein each said first information transmitting apparatus is comprised of at least an MPEG2 encoder, said second information transmitting apparatus is comprised of at least an MPEG2 decoder, and said frequency information includes a program clock reference (PCR).

3. An information transmission system as set forth in claim 1, wherein video/audio information in addition to said frequency information is transmitted to non-selected first information transmitting apparatuses whose video/audio information is not received by said second information transmitting apparatus.

4. An information transmission system as set forth in claim 1, wherein only said frequency information and the minimum extent of information required for forwarding of information are transmitted to non-selected first information transmitting apparatuses whose video/audio information is not received by said second information transmitting apparatus.

5. An information transmission system as set forth in claim 1, wherein:
said second information transmitting apparatus has said frequency information transmitting unit inside an information relay/transfer apparatus which transfers said video/audio information between any two of said plurality of first information transmitting apparatuses, and
non-selected first information transmitting apparatuses other than said any two first information transmitting apparatuses synchronize system clocks with said second information transmitting apparatus.

6. An information transmission system as set forth in claim 5, wherein each of said plurality of first information transmitting apparatuses is provided with a video signal source, said frequency information transmitting unit in said information relay/transfer apparatus is made to synchronize with a video reference signal from the outside, and said video signal source is made to synchronize with said video reference signal.

7. An information transmission system as set forth in claim 2, wherein each of said plurality of first information transmitting apparatuses is provided with an I-picture generation timing control unit, and the generation of said I-picture transmitted from each first information transmitting apparatus is shifted from each other with reference to the timing of arrival of said frequency information from said frequency information transmitting unit under the control of said I-picture generation timing control unit.

8. An information transmitting apparatus working with a plurality of remote information transmitting apparatuses each operating based on a system clock and selectively receiving video/audio information from said plurality of remote information transmitting apparatuses, provided with a frequency information transmitting unit for distributing frequency information relating to said system clock to the plurality of remote information transmitting apparatuses in common to enable each of said plurality of remote information transmitting apparatuses to synchronize its system clock with said information transmitting apparatus.

9. An information transmitting apparatus as set forth in claim 8, wherein when each said remote information transmitting apparatus is comprised of an MPEG encoder, said information transmitting apparatus is comprised of an MPEG decoder and said frequency information is information including a program clock reference (PCR).

10. An information transmitting apparatus as set forth in claim 8, which further transmits to non-selected remote information transmitting apparatuses not receiving said video/audio information video/audio information in addition to said frequency information.

11. An information transmitting apparatus as set forth in claim 8, which further transmits to non-selected remote information transmitting apparatuses not receiving said video/audio information only said frequency information and the minimum extent of information required for forwarding of information.

12. An information transmitting apparatus as set forth in claim 8, which forms an information relay/transfer apparatus which transfers said video/audio information between any two of said plurality of remote information transmitting apparatuses, has said frequency information transmitting unit inside it, and synchronizes said system clock with non-selected remote information transmitting apparatuses other than said any two remote information transmitting apparatuses.

13. An information transmitting apparatus as set forth in claim 8, wherein when each of said plurality of remote information transmitting apparatuses is provided with a video signal source and each said video signal source is made to synchronize with an outside video reference signal, said frequency information transmitting unit in said information relay/transfer apparatus is made to synchronize with said outside video reference signal.

14. An information transmitting apparatus among a plurality of information transmitting apparatuses each selectively supplying video/audio information to a remote information transmitting apparatus and operating by a system clock, provided with a system clock synchronizing unit operating with received frequency information relating to said system clock distributed from said remote information transmitting apparatus for synchronization of a system clock with said remote information transmitting apparatus.

15. An information transmitting apparatus as set forth in claim 14, wherein when said remote information transmitting apparatus is comprised of an MPEG decoder, said information transmitting apparatus is comprised of an MPEG encoder and said frequency information is information including a program clock reference (PCR).

16. An information transmitting apparatus as set forth in claim 14, which, when said information transmitting apparatus is an apparatus, among said plurality of information transmitting apparatuses, which does not supply video/audio information to said remote information transmitting apparatus, further receives video/audio information in addition to said frequency information from said remote information transmitting apparatus.

17. An information transmitting apparatus as set forth in claim 14, which, when said information transmitting apparatus is an apparatus, among said plurality of information transmitting apparatuses, which does not supply said video/audio information to said remote information transmitting apparatuses, receives only said frequency information and the minimum extent of information required for forwarding of information from said remote information transmitting apparatus.

18. An information transmitting apparatus as set forth in claim 14, wherein said information transmitting apparatus is provided with a video signal source and when said video signal source is made to synchronize with an outside video reference signal, receives said frequency information synchronized with said outside video reference signal from said remote information transmitting apparatus.

19. An information transmitting apparatus as set forth in claim 14, wherein said information transmitting apparatus has an I-picture generation timing control unit and adjusts the timing of generation of said I-picture to be transmitted with reference to the timing of arrival of said frequency information from said remote information transmitting unit.
